(19) United States
(12) Patent Application Publication
(10) Pub. No.: US 2024/0247415 A1
(43) Pub. Date: Jul. 25, 2024

(54) METHOD FOR CONFIGURING AND APPLYING AN OPTICAL ILLUSION PATTERN TO AN ARTICLE OF MANUFACTURE

(71) Applicant: Joseph Baxter, Elverta, CA (US)

(72) Inventor: Joseph Baxter, Elverta, CA (US)

(21) Appl. No.: 18/099,883

(22) Filed: Jan. 20, 2023

(51) Int. Cl. D04B 1/12; D03D 1/00; D03D 15/547

(52) U.S. Cl. CPC D04B 1/126; D03D 1/0011; D03D 15/547

(57) ABSTRACT

A method for embedding alphanumeric text into a pattern and providing a literal optical illusion that distorts the alphanumeric text as a solid line at a distance and provides legible alphanumeric characters at a close proximity. The pattern being woven into a textile material or printed onto a surface.

### FIELD OF THE INVENTION

The present invention relates generally to various articles of manufacture having a pattern thereon created by an embedded text and pictograph that creates an optical illusion at certain distances and a method of applying the pattern to articles of manufacture. More particularly, the present invention includes a pattern with a literal optical illusion constructed using a plurality of blocks with an equal distribution of empty space and text space.

### BACKGROUND OF THE INVENTION

Optical and literal illusions are often used to play tricks on the mind and are used in art, and print patterns that are applied to some materials. Such optical illusions use techniques of embedding an image into the foreground or background of an image using a grayscale or gradient to hide the image with line segments, the images are revealed when a person changes their perspective of the image. The perspective change may be by shaking, rotating, closing, or opening a distance.

Many literal illusion images are created using a plurality of smaller images formed in a grid pattern, and the smaller images are visible when zoomed in on or looked at closely. Such grid patterns are used in collages to form a person, landscape, or hyper-realistic image using elements of the formed image. While there has been significant success using a plurality of images in grayscale to generate an image or pattern, the same or similar techniques used with alphanumeric character is unsuccessful due to overlapping and inconsistent phrases. A method for embedding full phrase text into an image and grid pattern for application to a material is needed.

### SUMMARY OF THE INVENTION

The present invention provides a geometric pattern containing hidden and embedded text and a method for generating such a pattern and applying the pattern to different material surfaces. The geometric pattern may produce a literal optical illusion and includes a plurality of blocks or other repeated shapes in a substantially uniform series, array, or sequence to generate a desired image or pattern. Each shape in the plurality of repeating shapes may have an equal size and a substantially equal distribution of text and white space. The term “white space” is a void between the text space or an empty space and does not identify a specific color or shade. The text space may include any series of alphanumeric characters configured with uniform spacing and font size (e.g., point font) to generate a phrase or sequence. The text space includes the empty space between letters and is better characterized by the area occupying the text, such as the horizontal and vertical distribution of the alphanumeric characters. The white space may be configured between the text space and may have an area corresponding to the text space.

In some embodiments, the shapes may be patterned such that adjacent instances of the shape may have an inversely proportionate text space and white space with respect to the adjacent shape, such that when superimposing a first shape onto a second shape, the alphanumeric text of the second shape occupies the whitespace of the first shape. In some embodiments, a plurality of identical shapes may be arranged in a linear array or series where the text space of each shape aligns with the text space of adjacent blocks, and the alphanumeric character or phrase is completed. In such embodiments, the identical linear blocks may be arranged in a horizontal, vertical, or angular distribution but have a centerline that is constant with respect to the centroid of the first block.

A plurality of different block segments may be arranged in a grid to form a geometric pattern having an embedded literal illusion of a solid line at a far distance and an alphanumeric phrase at a close distance. The repeating shape arrangement may be operable to form various patterns, for example, but not limiting to, Plaid, Argyle, Chevron, Stripes, Houndstooth, gingham, basketweave, checker, Fret, Lattice, diamond on diamond, harlequin, herringbone, etc. In some embodiments, for example, but not limiting to, the various block segments may have different fonts (e.g., Arial, Times, Garamond, etc.) and may have an effect including solid, outlined, glowing, and reflected into the white space. In some embodiments, the text space forming the patterns may have alphanumeric characters with a color (e.g., RGB, CMYK, greyscale, Pantone, etc.) transitioning in opacity, transparency, and gradient to assist in simulating the patterns at a distance.

In some embodiments, the text space of the different block segments may include various shapes (e.g., stars, triangles, dollar/peso sign, etc.), logos (e.g., design mark illustrations), and illustrations (e.g., football, basketball, mountain, etc.), other than non-alphanumeric characters, that are constructed in a vector illustration having at least one color. The various shapes may have a reduced size and may be visibly indistinguishable at a far distance and clear at a close distance. In such embodiments, the various shapes may be spaced evenly within the text space of the block and may have an equivalent white space distance. The configuration of the blocks in the space may form a grid pattern and provide an optical literal illusion of solid lines.

The method for providing a system using dimensioned letters or text that replace the traditional line segments in manufacturing and textile construction for clothing, signage, stickers, and other articles of manufacture. The method provides a pattern consisting of alphanumeric characters, and having a distancing and spacing that provide an illusion of a solid line at any distance beyond a pre-determined threshold distance and provides a visible text script at a distance that is closer than the pre-determined threshold distance.

It is an aspect of the present invention, to provide a method of producing a geometric pattern of hidden alphanumeric characters which includes a block having a square boundary with a symmetric plane where a white space segment, and an alphanumeric segment of equal space is distributed evenly on each side of the symmetric plane; cropping the alphanumeric segment at the boundary; and creating a plurality of copies of the block and positioning the copies in a grid, where alphanumeric segments of a first block align with the alphanumeric segments of an adjacent block; the grid may form a pattern of alphanumeric characters and white space that is visually legible at a close proximity and distorted to a solid line at a distance. The symmetric plane may be bisected from the top left corner to the bottom right corner of the square boundary. Each side of the plane may have an equal and opposite distribution of alphanumeric segments and whitespace segments. The alphanumeric segments may be positioned in a staggered orientation and read in the same direction. The method may include a second block having an alphanumeric segment corresponding to the white space segment of the first block and a white space segment corresponding to the alphanumeric segment of the first block. The method may include aligning the first block and the second block vertically, horizontally, and along the symmetric plane in a sequence to create the pattern. The alphanumeric segment may include text characters having an equal font and text size. The pattern may be woven into a textile material. The pattern may be printed onto a surface and applied to a material.

It is a further aspect of the present invention to provide, a pattern displaying a literal optical illusion that may be applied to a material and includes: a plurality of blocks arranged in a grid, where each block is formed by at least one segment; a first segment may have an equilateral boundary defining a plurality of text spaces containing a series of alphanumeric characters and a plurality of empty space; a second segment may have a boundary complementary to the first segment and contain a text space corresponding to the first segment empty space and an empty space corresponding to the first segment text space; and an integrated block segment formed by geometrically aligning the first and second segments; the integrated block segment, first segment, and second segment are sequenced in the grid to form a pattern that is operable to be applied to a material, the pattern displaying a legible text at a close proximity and having a solid appearance at a far distance. The plurality of blocks arranged in a grid may include a uniform constant sequence of the integrated block segment, first segment, and second segment that are aligned laterally and longitudinally at a periphery. The geometric alignment of the first and second segments may be configured by aligning the center or corner of the first block segment boundary with the center of the second segment boundary. The blocks forming the grid pattern may be arranged such that the text spaces and empty spaces of adjacent blocks are aligned. The text spaces may form a phrase of alphanumeric characters. The equilateral boundary may be substantially square, and the text space and empty space may be configured at an angle and distributed symmetrically along the corners. The text space and empty space encompass the same area in the boundary of the segment. The integrated block may be duplicated laterally and longitudinally and along a symmetric plane therebetween. The pattern may be applied to a material, woven into a textile, and printed onto a textile. The pattern may be applied to a material by printing the pattern onto a vinyl sticker. The alphanumeric characters are configured to display embedded messages.

Further aspects and embodiments will be apparent to those having skill in the art from the description and disclosure provided herein.

It is an object of the present invention to provide a method for applying a literal optical illusion of text and solid lines to a material.

The above-described objects, advantages and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides an exemplary view of a plaid pattern applied to a textile material, according to an embodiment of the present invention.

FIG. 2 provides an expanded close-up view of the plaid pattern about the dotted line P100 of FIG. 1

FIG. 3A provides an expanded close-up view of a first block of the plaid pattern, of FIG. 1.

FIG. 3B provides an expanded close-up view of a second block of the plaid pattern, of FIG. 1.

FIG. 3C provides an array of a combined first block of FIG. 3A and the second block of FIG. 3B, according to an embodiment of the present invention.

FIG. 4 provides a plaid pattern applied to a textile material, according to an embodiment of the present invention.

FIG. 5 provides an exemplary bounding box for a block segment, according to an embodiment of the present invention.

FIG. 6 provides alphanumeric text, according to an embodiment of the present invention.

FIG. 7 provides an uncropped first block segment, according to an embodiment of the present invention.

FIG. 8 provides an uncropped second block segment, according to an embodiment of the present invention.

FIG. 9 provides a first block segment, according to an embodiment of the present invention.

FIG. 10 provides a rotated first block segment, according to an embodiment of the present invention.

FIG. 11 provides a rotated second block segment, according to an embodiment of the present invention.

FIG. 12 provides a combined first and second block segment, according to an embodiment of the present invention.

FIG. 13 provides an array of combined first and second block segments, according to an embodiment of the present invention.

FIG. 14 provides a combined first and second block segment, according to an embodiment of the present invention.

FIG. 15 provides a distant perspective view of a pattern using the block segment of FIG. 10 and the block segment of FIG. 11, according to an embodiment of the present invention.

FIG. 16 provides a less distant perspective view of a pattern using the block segment of FIG. 10 and the block segment of FIG. 11, according to an embodiment of the present invention.

FIG. 17 provides a close-up perspective view of the pattern of FIG. 15.

FIG. 18 provides a close-up perspective view of the pattern of FIG. 16.

FIG. 19 provides an exemplary perspective view of a pattern according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

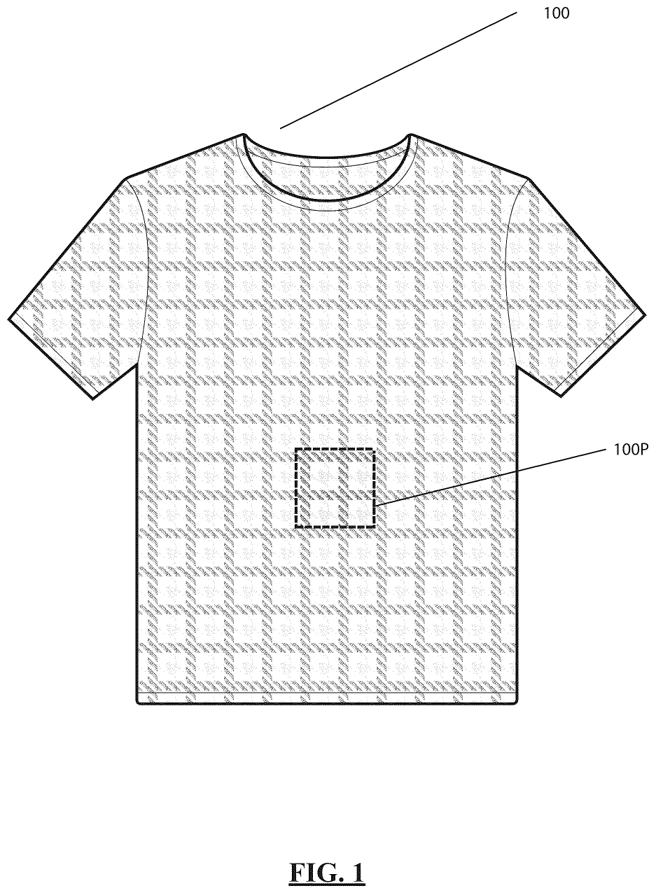

Referring to the drawings, wherein like reference characters designate like or corresponding parts throughout the several views, and referring particularly to FIGS. 1-18, it is seen that the present invention includes various embodiments of a pattern, comprising a plurality of different blocks containing white space and alphanumeric character distributions that, when configured, are operable to provide a literal illusion of a solid line at a distant perspective and intelligible text at a close perspective.

The present invention concerns a geometric pattern that may be applied to a surface, woven into a textile material, or other exterior surface applications and finishes. FIG. 1 provides a distant perspective view of an exemplary T-shirt 100 incorporating an exemplary plaid pattern 100p. The exemplary T-shirt 100 may have at least two corresponding block segments that have a substantially symmetric text and white space distribution. The blocks forming the pattern 100p may have varying or different grayscale coloring.

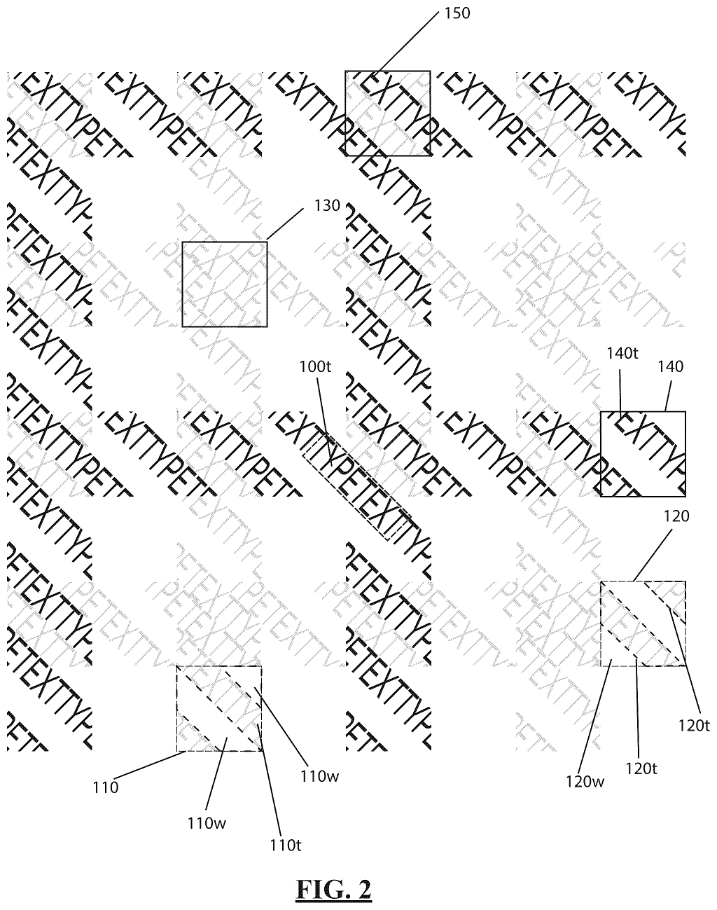

In some embodiments, as illustrated in the close-up view of the houndstooth pattern 100p, see FIG. 2, the exemplary alphanumeric text 100t reads “TYPETEXT”. The pattern 100p may have at least two block segment types, a first segment 110 and a second segment 120. The two segment blocks have a whitespace corresponding to the text space. The first segment 110 may have an angular distribution of white spaces 110w and text spaces 110t that are symmetric about the centerline of the segment 110. Similarly, the second segment 120, may have a symmetric distribution of white space 120w and text space 120t. In some pattern types, the first segment 110 and second segment 120 may be centrally aligned with the center of the block segments, and the text space 120t may occupy the white space 110w of the first block segment 110 and may intersect, forming a solid block as shown in block 130. In other implementations, the block segments may have a different shading of color (e.g., grayscale, RGB, CMYK, Pantone, etc.), for example, block segment 140 has the same distribution of text and white space as shown in segment 110, but the alphanumeric characters in the text space 140t have a solid black color. The block segment 140 and block segment 120 may intersect, forming a perspective as shown in block 150.

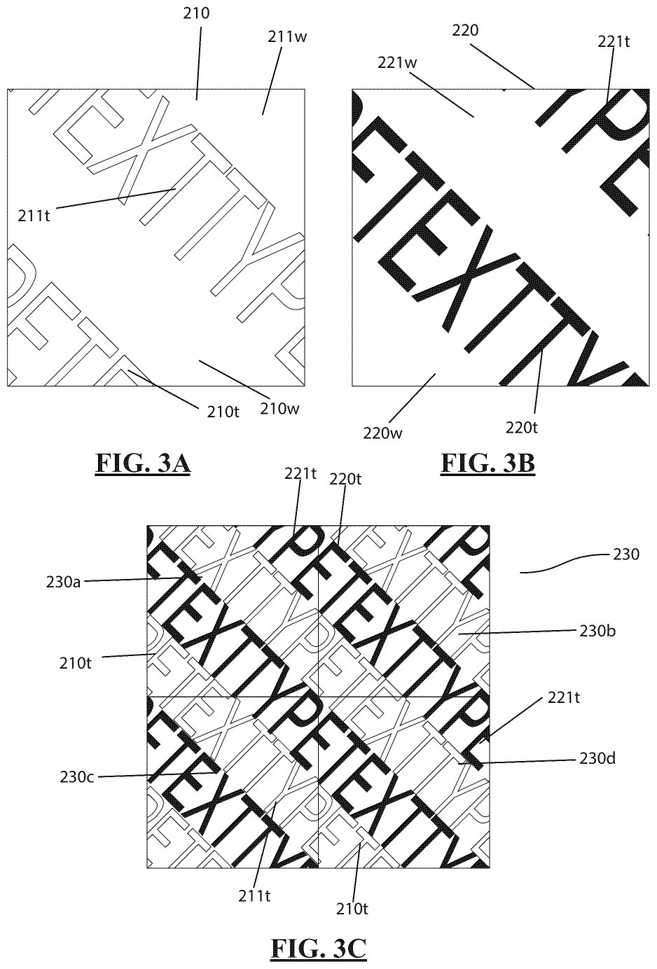

In some embodiments, the alphanumeric characters may have various effects applied to the text. FIGS. 3A and 3B provide expanded close-up views of a first block segment 210 and a second block segment 220. The first block segment 210 includes the text spaces 210t, 211t with outlined alphanumeric characters, and the second block segment 220 includes text spaces 220t, 221t with solid alphanumeric characters. FIG. 3C illustrates an exemplary pinstriped pattern 230 constructed from the first and second block segments 210, 220, the pattern 230 may have an angular orientation and may include a plurality of identical blocks 230a, 230b, 230c, and 230d. The blocks 230b, 230c, and 230d may be duplicates of a parent block 230a which is constructed by aligning the centers of the first and second block segment 210, 220. The blocks 230a-230d may have an equidistant distribution where the perimeter of each block aligns with the periphery of the adjacent blocks. The text space 210t of the parent block 230a aligns with the text space 220t of the duplicate block 230b and the text space 221t of the duplicate block 230d aligns with the text space 220t of the block 230b, and completes the alphanumeric text “TEXTTYPE” 100t.

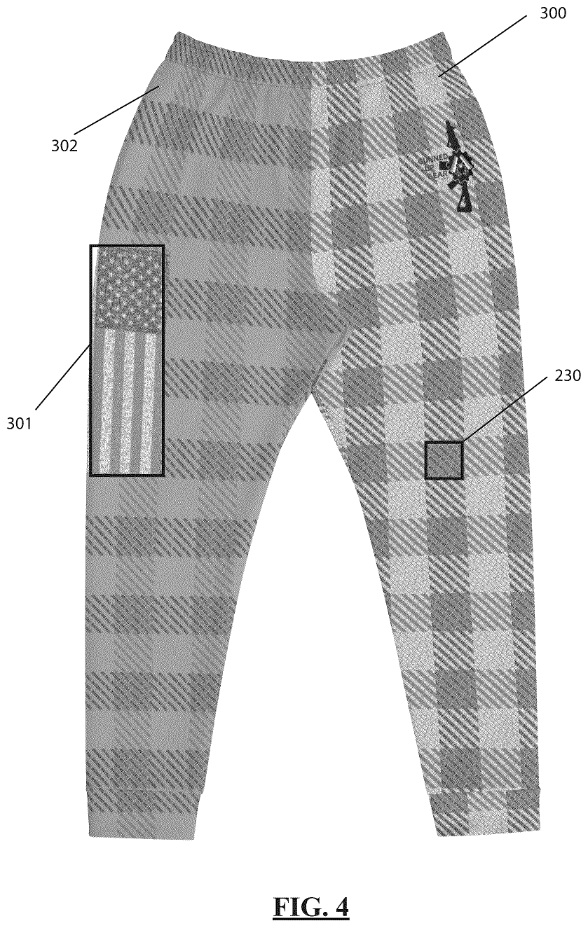

The pattern 230 and other first and second block segment 210, 220 configurations may be arranged to form various patterns as illustrated in FIG. 4. The textile clothing article 300 may have the pattern woven into the material, or applied to the material with embroidery printing, Computer-Aided Design (CAD) cut vinyl, soft print transferring, direct garment printing, screen printing, etc. The clothing article may have a solid foreground 302 and various colored block segment configurations may be distributed uniformly to provide an illusion of solid lines at a distance and display legible text from a close perspective. The segments 210, 220, may also be configured to display a symbol or illustrate a picture, as shown with the flag representation 301.

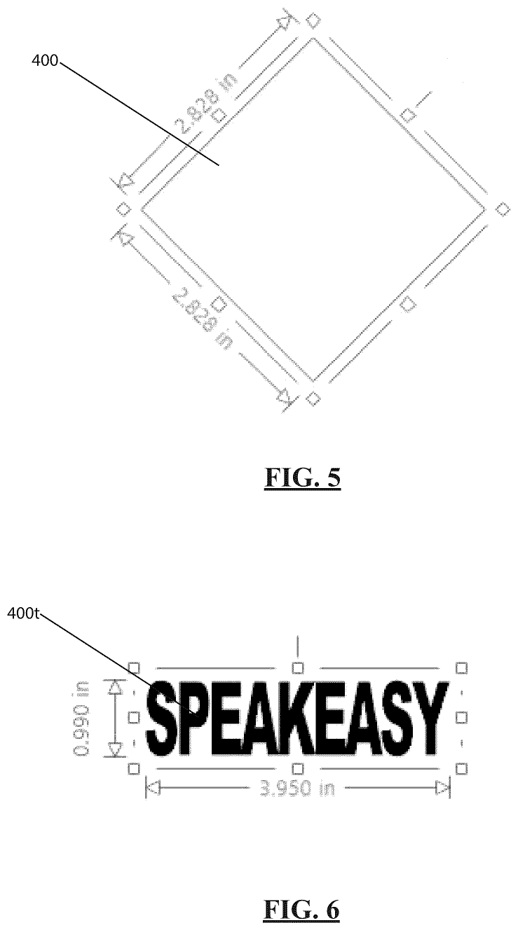

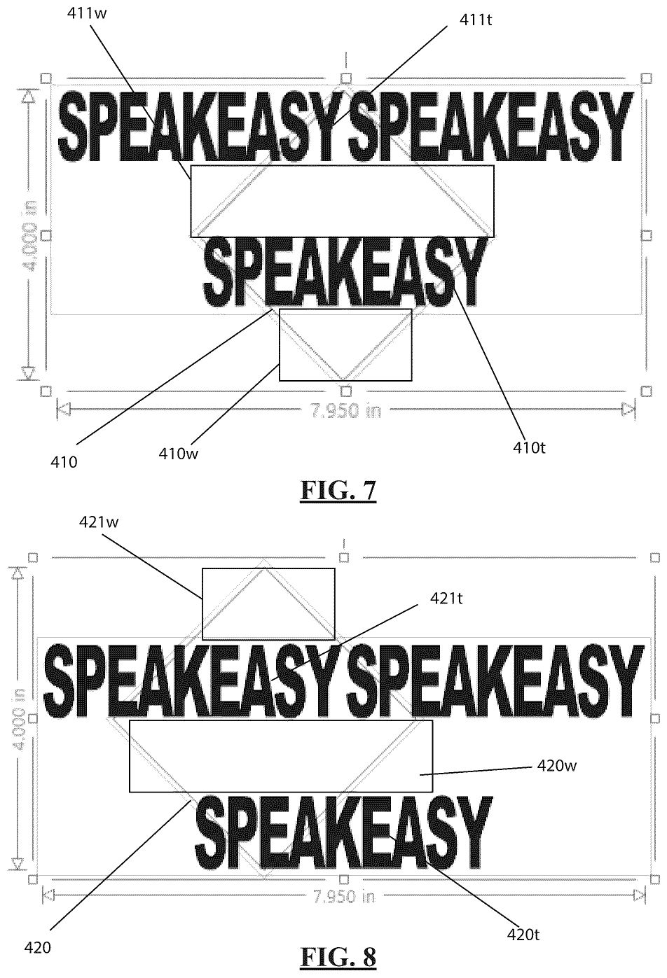

FIGS. 5-14 illustrate the steps for generating a first block 410 and a second block 420 segments using a 2D CAD illustration software system (e.g., Microsoft Paint, Adobe Illustrator, Silhouette studio, etc.). The dimensions throughout the FIGS are exemplary, not to scale, and the height and width used in illustrating the relationship of a first and second segment, may be of a different sizing, ratios, and dimensions, and depend largely on the printing surface, material, desired perspective, and the application. A first step may be to define a square block size to crop the white space and text space of the block segment, as shown in FIG. 5, a block outline 400 having a square perimeter with the corners intersecting a horizontal and vertical plane. The alphanumeric text 400t “SPEAKEASY” shown in FIG. 6 may be used throughout the remaining FIGS. A first block segment 410, shown in FIG. 7, may be constructed by aligning the top edge of the first text space 410t with the center of the block 410, the second text space 411t may have duplicated text 400t immediately adjacent to each other and the center of the text space 411t may be positioned in the center adjacent to the top intersection of the block 410. The white space 411w may be positioned between the first and second text spaces 410t, 411t and may take up the same area. The second segment block 420 shown in FIG. 8, may have a first and second text space 420t, 421t that corresponds to the white space 411w of the first segment block 410. The second segment block 420 may also have the white space 420w, 421w that are positioned inverse to the first block 410.

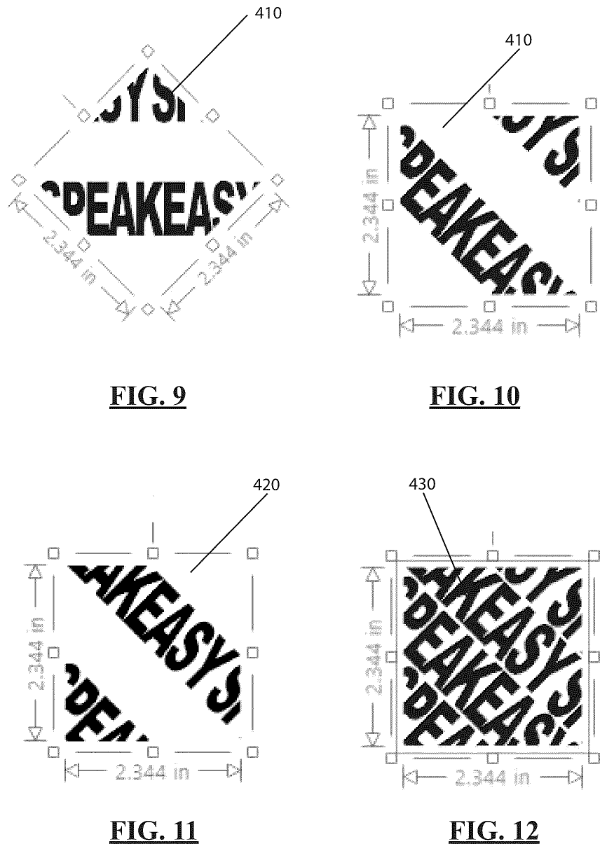

In the following step, a cropping or clipping mask operation may be performed, and the alphanumeric characters 410t, 411t that cross the boundary of the block outline 400 are eliminated, and the text inside remains as shown in the first block segment 410 illustrated in FIG. 9. The first block segment 410 may be rotated to the desired orientation, as shown in FIG. 10. The same operation performed for the first block segment 410 is performed on block 420, as illustrated in FIG. 11. It is shown that the block counterparts are complementary, and the text spaces correspond to the white spaces of the corresponding block as illustrated in the combined block 430 of FIG. 12.

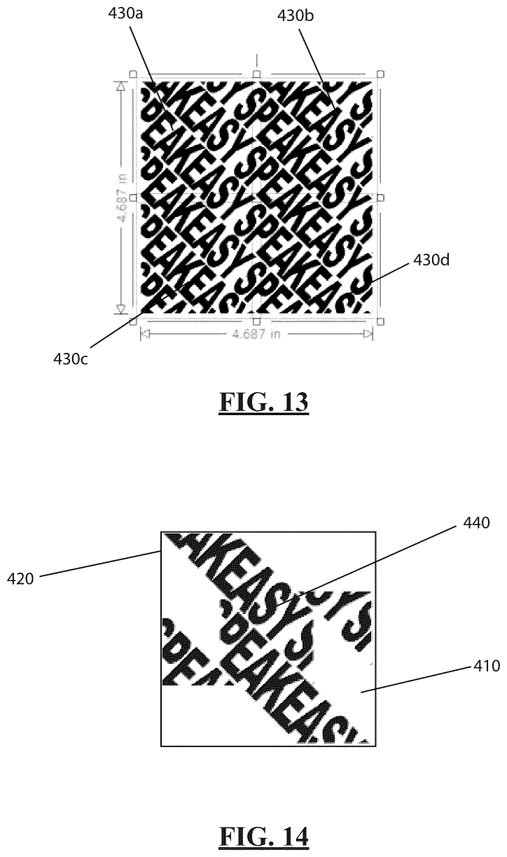

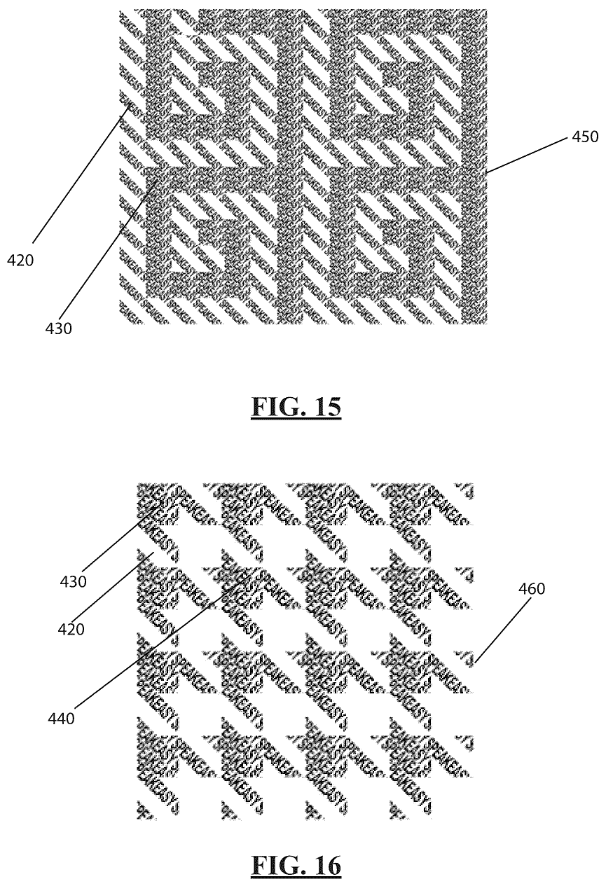

The block segments 410, 420 may then be arranged in a space or grid to generate a desired pattern or be equilaterally aligned for a complete block. Equilateral alignment includes aligning the centers and corners of the first and second block segments 410, 420 to form a complete block 430, as shown in FIG. 12. In some embodiments, the complete block 430 may be a parent block 430a and may have duplicate blocks 430b, 430c, and 430d that are aligned at the corners and their perimeter edges to form the pattern illustrated in FIG. 13.

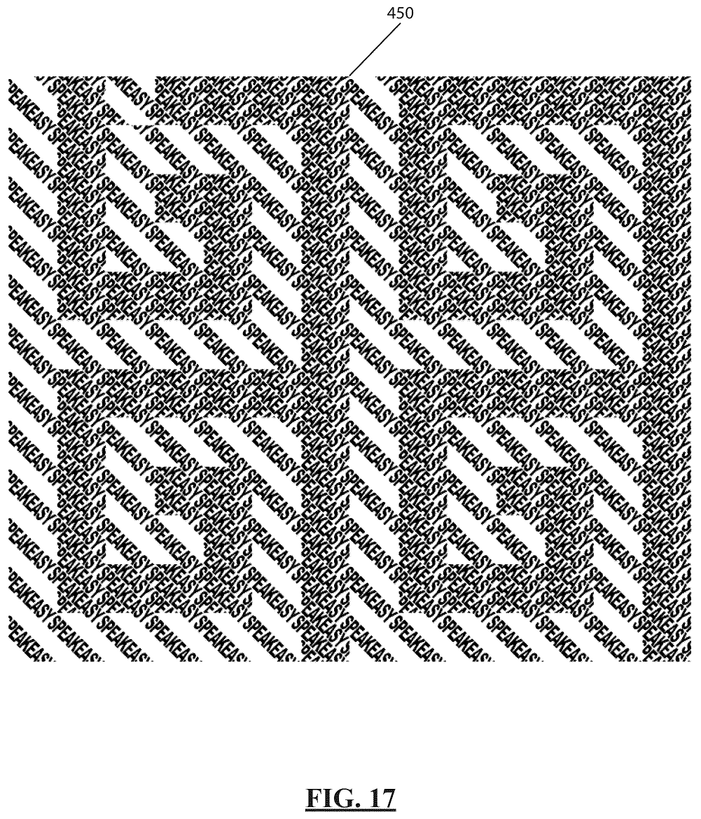

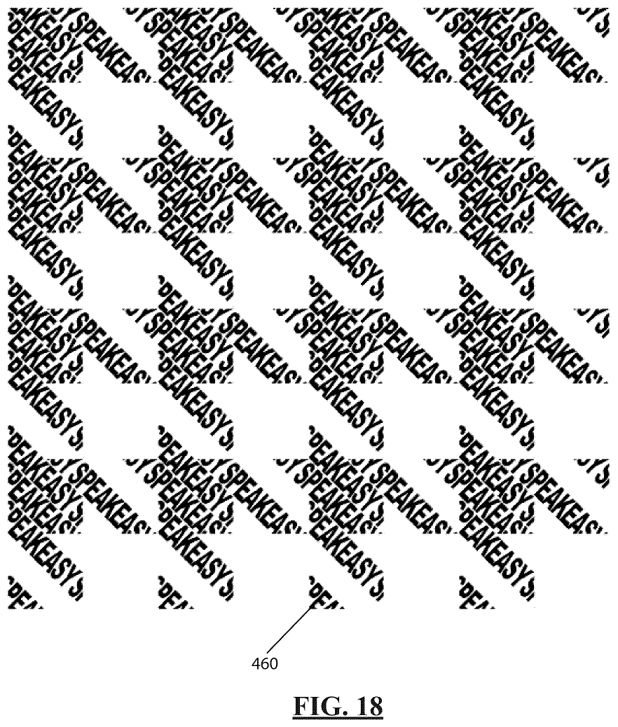

In some embodiments, the first segment block 410 may be evenly offset from the second block 420 to form a complete block 440, as illustrated in FIG. 14. In such embodiments, the upper left corner of the first segment 410 is aligned with the center of the second segment 420, and the bottom right corner of the second block 420 aligns with the center of the first segment block 410. The completed block 440 illustrates an exemplary Houndstooth pattern. Various patterns may be created using the first and second block segments 410, 420, completed block 430, and completed block 450 with a uniform distribution as shown in FIGS. 15-18. FIG. 17 provides a close-up view of the pattern 450 of FIG. 15 and illustrates a pattern using second block segments 420 and a completed block 430 to create the pattern. FIG. 18 provides a close-up view of the expanded pattern 460 of FIG. 16 and illustrates a Houndstooth pattern evenly distributed. In some embodiments, the text space, white space, and a pattern may have various gradients of color applied to the pattern to provide perspective and illusions.

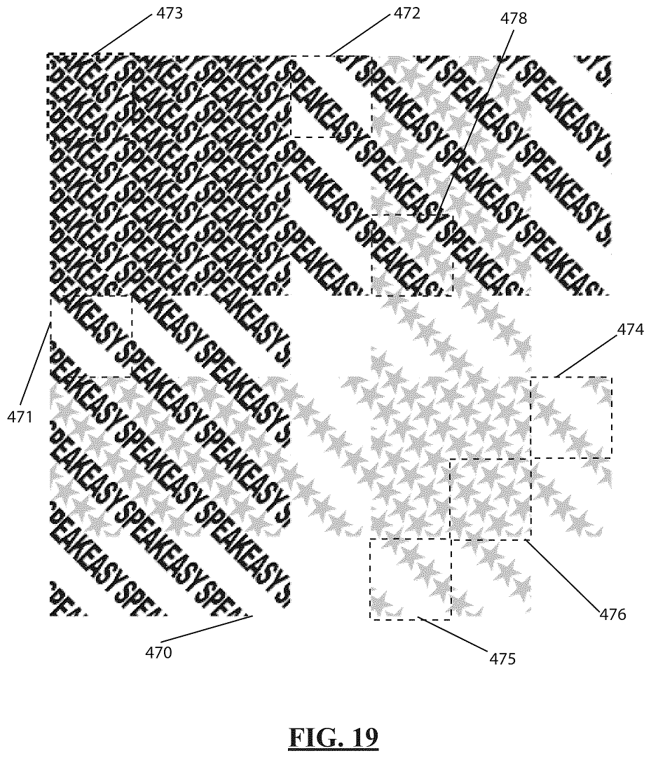

In some embodiments, as illustrated in FIG. 19 a plaid pattern 470 may include combination blocks 478, including alphanumeric text blocks 471, 472 and pictographic text blocks 474, 475. In such embodiments, the pictographic text blocks 474, 475 may be complementary and form a uniform block 476 containing a plurality of pictographic (e.g., stars) in a series. The pattern may include a complete block 473 containing alphanumeric texts, a complete block 476 of pictographic, and a combination block 478 containing both. In such plaid patterns 470, there may be empty space blocks 477.

What is claimed is:

1. A method of producing a geometric pattern of hidden alphanumeric characters comprising:
a. a block having a square boundary with a symmetric plane wherein a white space segment, and an alphanumeric segment of equal space is distributed evenly on each side of said symmetric plane;
b. cropping said alphanumeric segment at said boundary; and
c. creating a plurality of copies of said block and positioning said copies in a grid, wherein said alphanumeric segments of a first block align with the alphanumeric segments of an adjacent block;
wherein said grid forms a pattern of alphanumeric characters and white space that is visually legible at a close proximity and distorted to a solid line at a distance.

2. The method of claim 1, wherein said symmetric plane is bisected from a top left corner to a bottom right corner of said square boundary.

3. The method of claim 2, wherein each side of said plane has an equal and opposite distribution of alphanumeric segments and whitespace segments.

4. The method of claim 3, wherein said alphanumeric segments are positioned in a staggered orientation read in the same direction.

5. The method of claim 1, further comprising a second block having an alphanumeric segment corresponding to the white space segment of said block and a white space segment corresponding to the alphanumeric segment of said block.

6. The method of claim 5, further comprising aligning said first block and said second block vertically, horizontally, and along said symmetric plane in a sequence to create said pattern.

7. The method of claim 1, wherein said alphanumeric segment further comprises text characters having an equal font and text size.

8. The method of claim 1, wherein said pattern is woven into a textile material.

9. The method of claim 1, wherein said pattern is printed onto a surface and applied to a material.

10. A pattern displaying a literal optical illusion that is applied to a material, the pattern comprising:
a. a plurality of blocks arranged in a grid, wherein each block is formed by at least one segment;
b. a first segment having an equilateral boundary defining a plurality of text spaces containing a series of objects and a plurality of empty spaces;
c. a second segment having a boundary complementary to said first segment and containing a text space corresponding to said first segment empty space and an empty space corresponding to said first segment text space; and
d. an integrated block segment formed by geometrically aligning said first and second segments;
wherein said integrated block segment, first segment, and second segment are sequenced in said grid to form a pattern that is operable to be applied to a material, said pattern displaying a distinguishable text space at a close proximity and having a solid appearance a far distance.

11. The pattern of claim 10, wherein said plurality of blocks arranged in a grid is further comprising a uniform constant sequence of said integrated block segment, first segment, and second segment that are aligned laterally and longitudinally at a periphery.

12. The pattern of claim 10, wherein said geometrically aligning of said first and second segments is configured by aligning a center or corner of said first block segment boundary with a center of said second block segment boundary.

13. The pattern of claim 10, wherein said blocks forming said grid pattern are arranged such that the text spaces and empty spaces of adjacent block are aligned.

14. The pattern of claim 13, wherein said text spaces form a phrase comprising alphanumeric characters.

15. The pattern of claim 10, wherein said equilateral boundary is substantially square and said text space and empty space is configured in the boundary at an angle and are distributed symmetrically along the corners.

16. The pattern of claim 10, wherein said text space and empty space encompass the same area in said boundary of said segment.

17. The pattern of claim 10, wherein said integrated block is duplicated laterally and longitudinally and along a symmetric plane therebetween.

18. The pattern of claim 10, wherein said pattern is applied to a material is a woven into a textile, printed onto a textile.

19. The pattern of claim 10, wherein said pattern is applied to a material by printing the pattern onto a vinyl sticker.

20. The pattern of claim 10, wherein said text space forms a series of distinguishable objects including various shapes, design logos, and illustrations.
